(19) United States
(12) Patent Application Publication
(10) Pub. No.: US 2012/0022971 A1
(43) Pub. Date: Jan. 26, 2012

(54) SECURE ELECTRONIC FINANCIAL FUNDS TRANSFER ARRANGEMENT

(76) Inventors: Steven Alexander Morris, South Australia (AU); Nikolaos Lymperis, Rhodes (GR); Efthimia Sarantidou, Rhodes (GR)

(21) Appl. No.: 13/147,252

(22) PCT Filed: Feb. 2, 2010
(86) PCT No.: PCT/AU10/00111

§ 371 Date: Oct. 10, 2011

(30) Foreign Application Priority Data
Feb. 3, 2009 (AU) 2009900384

(51) Int. Cl. G06Q 30/00; G06Q 20/00

(52) U.S. Cl. 705/26.42; 705/64

(57) ABSTRACT

A secure electronic financial funds transfer arrangement including: a funds provider entity who issue a voucher to a customer after registration; a customer seeking to purchase goods and services from a merchant utilising electronic means, or other means intending delivery of valuable goods to the registered address; a verification means available to the merchant with the funds provider entity and whereupon said validation of the voucher issued by the funds provider entity to the customer will result in the transfer of financial funds from the funds provider entity to the merchant and the delivery of the selected goods and/or services to the registered address made by the customer during the registration process before the financial funds transfer voucher was issued by the funds provider entity.

### FIELD OF THE INVENTION

This invention relates to a secure way in which to complete electronic financial fund transfer arrangements between a merchant and a customer trading with various goods and/or services.

More particularly this invention relates to a very unique secure electronic financial funds transfer arrangement between a merchant and a customer wherein the identify of the customer can remain optionally unknown to the merchant albeit the funds transferred between the merchant and the customer will always result in the purchased goods and/or services arriving at a safe fixed secured address. For instance, a pre registered home, business, commercial, industrial or other address.

### TECHNOLOGICAL FIELD

Buying goods and services on-line through the world wide web these days is about as commonplace as the conventional way of the customer visiting a store in person where face to face transactions are completed between a store's sales assistant and the customer per se.

Nonetheless with the advent of the world wide web and other electronic communication arrangements through the use of mobile telephones, PDA's, PC's and so forth many merchants have been able to present their wares to members of the purchasing public not through a physical shop or store per se but in fact in amongst an electronic ether where web-sites and so forth provide portal access for a customer to engage the merchant's store virtually to make a selection of the required goods or service for purchase.

While for the most part the introduction of the merchant's goods and services to the various members of the purchasing public involves just the interaction of the merchant and the customer, ultimately once the customer has decided on a selection of products or services that need to be purchased there is the requirement to introduce a third party as a means of establishing a financial link or transfer to complete the trade of the respective goods and services between the merchant and the customer.

For the most part these payment arrangements are often completed with the customer using a credit card, which is Visa, MasterCard, American Express and so forth wherein when prompted at the time of checkout from the virtual sale that has been completed between the merchant and the customer, the customer would then input his or her credit card details to have them verified by the merchant by the relevant credit card organisation.

As most of us are already well aware there is significant misappropriation of credit card details that are input during legitimate financial commercial transactions between customer and merchant. While merchants' sites are supposedly meant to be secure the fact is customer identity and credit card information is being observed by unscrupulous third parties and then used in unauthorised subsequent transactions thereafter.

This potential threat of a customer's theft of credit card and so forth for unauthorised usage by criminals as well as the potential for identify fraud and so forth has meant that a large portion of the purchasing public has avoided becoming involved in electronic commercial trading of goods and services between merchant and customers. Accordingly many merchants are missing out on a potential pool of customers who are reluctant to place themselves at risk when it comes to the use of electronic buying of goods and services and the fact from a physical point of view these customers would not be in a position to ever access physically one of the stores available by the merchant because of the fact that the customer resides in a location which would make it far too inconvenient.

Still further there are many of those in the purchasing public who are unable to obtain credit cards for whatever reason, and while their past makes such customers accountable the fact remains is that such people would still like the opportunity of purchasing various goods and services legitimately on-line through electronic means.

As they are not in a position to obtain credit cards and so forth from banking institutions and other credit providers they are physically unable then to purchase product on-line which means that once again the overall pool of customers available to buy a particular merchant's product would be less than otherwise desirable.

Still further even for those that can legitimately obtain credit cards one of the requirements of doing so through a banking institution is to provide very detailed and specific information in order that the banks and so forth can carry out adequate checking of those seeking a credit card to confirm their financial stability to maintain such a credit card facility. Given that so much information is required by the banking institution with this information being stored electronically it goes back to the problem introduced above where when the credit card is used given significant amounts of information are stored with that particular card opportunity for identity fraud is significant and for the most part complete.

Therefore there remains a need in the field of electronic financial fund transfer once commercial trade has been completed between a customer and a merchant that will overcome those problems introduced above in that for the most part when a financial transaction is complete and payment is made electronically, that the customer's identity cannot be defrauded, that the customer is able to make an electronic purchase despite the fact that he or she was unable to obtain a credit card from a financial institution and finally if the credit card and so forth was available and theft of the card took place, the criminal who sought use of such a credit card would find its usability unavailable because any purchase made would see the selection of goods or services bought by the thief being on-forwarded to the address of the rightful owner of the credit card. The system would not allow for ‘over the counter’ or pick up goods.

### SUMMARY OF THE INVENTION

A secure electronic financial funds transfer arrangement for the commercial trading of goods and/or services between a merchant and a customer wherein the identity of the customer remains optionally unknown to the merchant albeit the funds transfer between the merchant and the customer when goods and services are bought will result in those purchased goods and services being sent to an incorruptible customer address, said funds transfer arrangement including:
a funds provider entity;
said funds provider entity making available a financial funds transfer voucher through a registration means with a customer seeking to purchase goods and services from a merchant utilising electronic means;
said registration means requiring the customer to make a payment to the funds provider entity that will match the value, or a substantial amount thereto of the financial funds transfer voucher issued by the funds provider entity, and for the customer to list as part of the registration means a single, non-editable delivery address of the customer for all purchases made from the issued financial funds transfer voucher of the funds provider entity during commercial dealings with the merchant in the electronic trading medium;
a verification means available to the merchant such that when a customer makes a selection of goods and/or services of the merchant and wherein the customer uses the voucher issued by the funds provider entity for payment of the purchased goods and services from the merchant by electronic means, the merchant is able to utilise a verification means with the funds provider entity to determine that the voucher can financially cover said transaction between the customer and the merchant; and
whereupon said validation of the voucher issued by the funds provider entity to the customer will result in the transfer of financial funds from the funds provider entity to the merchant and the delivery of the selected goods and/or services to the registered address made by the customer during the registration process before the financial funds transfer voucher was issued by the funds provider entity.

An advantage of such an arrangement is that for the first time an arrangement has been put in place whereby even if the financial funds voucher was stolen and was used for unauthorised purchasing, the fact would remain is that all the transactions completed would see those goods and services purchased on-line, or for any delivery type purchase without authorisation being sent to the address of a customer who is issued with the financial funds transfer voucher in the first place.

Advantageously as the customer first registers with the funds provider entity to be issued with the financial funds voucher, it is the funds provider entity which provides the threshold test as to the suitability of a customer to be issued with a financial funds transfer voucher. Provided the money or the means is provided for by the customer at first instance to the funds provider entity a financial funds voucher can be issued and as part of the original registration means before the voucher is issued the customer must list his or her fixed delivery address.

This means that any subsequent transaction utilising the financial funds voucher will see the goods being delivered to that fixed address.

Regardless of the situation during an on-line exchange when the merchant will ask for delivery address details, if the financial funds transfer voucher is used as a means of making the payment between the customer and the merchant, when the merchant verifies the transaction with the funds provider entity this will cause the funds provider entity to prompt the merchant to make sure that the delivery of the selected product or services made by the user of the financial funds voucher is sent to the fixed address that was listed during the registration process.

Therefore regardless if someone has stolen the voucher and used it with authorisation the fact remains that during the verification means the merchant will be prompted to send the goods to a listed address which was confirmed during the legitimate registration process between the authorised user of the voucher and the funds provider entity before the financial funds transfer voucher was issued.

Advantageously with this arrangement the funds provider entity also need not know so many details about the customer who is seeking the purchase of a financial funds transfer voucher. Providing money is paid the funds provider entity will be happy to issue the financial funds voucher. Probably adhering to some security considerations.

What this means is that people can obtain the financial funds transfer voucher and use it for on-line payments but even if the commercial trade between the customer and merchant is being watched by unscrupulous criminal activity the details provided for by the user of the financial funds transfer voucher to the funds provider entity is limited in nature and therefore will not present enough detailed information for identity fraud to take place.

Advantageously also as already alluded to (preceding), given it is the funds provider entity who decides the threshold criteria required by someone to purchase from them a financial funds transfer voucher, means that many people who are unable to obtain a credit card, or unwilling/uncomfortable to transfer information linked to personal accounts and so forth to take part in financial exchange on the internet can still utilise this system and therefore for the first time the actual pool of available members of the purchasing public now in a position to buy product on-line has been dramatically increased.

In preference there is one proof of address can register for an alternate address, not the proof address, but only one address per voucher, hence multiple addresses for account customers.

Preferably the funds provider entity is a local representative, bank, etc, providing a locally accountable entity for the first purchase risk, i.e. Purchase of the funds transfer voucher.)

In preference the registration means between the customer seeking to be issued with a financial funds transfer voucher and the funds provider entity will also include the use of a nondescript identifier, for the purpose of verifying the correct entry of an account during the verification stage between the merchant and the funds provider entity.

In preference the financial funds transfer voucher would be a card, ticket, docket, invoice or receipt of purchase from the funds provider entity wherein the number presented on said card, ticket, docket, invoice or receipt of purchase of the funds provider entity represents a temporary, short-term, long-term, lifetime or an account over a period of time to be limited to the value placed on the card, ticket, docket, invoice or receipt of purchase by the funds provider entity.

In preference the electronic financial funds transfer arrangement includes a means for altering a delivery address of an issued financial funds transfer voucher when the customer who is issued with the financial funds transfer voucher during registration has vacated an existing delivery address wherein said relocation of address makes the original delivery address unavailable or invalid and wherein substituted therein is a new delivery address.

The preference here is to issue a non transferable refund and to arrange purchase of a new voucher registered to the new address.

In preference the registration means between the customer seeking the purchase of a financial funds transfer voucher with the funds provider entity is through a kiosk service or electronic funds transfer machine.

In preference the electronic funds transfer machine would include a customer interactive screen wherein the customer upon purchasing the financial funds transfer voucher will list his or her address, provide means or information about payment for the financial funds transfer voucher.

In preference the electronic funds transfer machine to which a customer is interacting with the funds provider entity to be issued with a financial funds transfer voucher, also includes a verification comparison step wherein recognisable identity documentation of the customer, including driver's license, national identity card or passport would be compared with the address detailed by the customer seeking the issuance of a financial funds transfer voucher from the funds provider entity.

In preference in a further form of the invention a customer seeking the purchase of a financial funds transfer voucher from the funds entity provider can utilise the world wide web to enter in registration details including that of the fixed delivery address and the means and amount for the payment of the financial funds transfer voucher.

In preference in a further embodiment of the invention the registration means allows for the completion of the registration process by the customer seeking the issuing of the financial funds transfer voucher to do so by telephone, either by operator or by other menu governed service.

In preference once the registration has been completed between the customer and the funds provider entity all address entry methods may be verified by a secondary process after registration, where a confirmation letter may be sent to the registered address.

In preference the verification either can contain a verification code which can be subsequently entered into a web-site or telephone menu system to activate the financial funds transfer voucher.

In preference the functionality of the verification system is to be determined in operational testing and may vary depending on regional and geographical logistics and so forth.

In preference the nondescript identifier, used for the purpose of the customer being able to verify correct entry of their financial funds transfer voucher will be displayed on the issued financial funds transfer voucher.

As the person skilled in the art will appreciate this process should occur by means of recalling the entered number and associated nondescript identifier from the card account database (digital, analogue, automated, manual or other). The nondescript identifier can then be compared to the one appearing adjacent to the financial funds transfer voucher number. This facility can be used by the customer and merchant to verify the authenticity of the financial funds transfer voucher being used in the transaction being completed between the respective parties.

Once initiated, the transaction process may operate in a number of multi-level or simple level verification and authentication of details and verification of transaction validity.

The first operating method being considered will be for a multi stage verification of transaction and payment authority between the funds provider entity and the merchant. In a further form of the invention means could be available for a retail-like instant transfer system whereby upon requesting payment from the funds provider entity, a customer (of a merchant, accepting direct deposit or funds provider entity financial facility services) authorise the payment system, most likely and preferably a “direct deposit—by request” to transfer funds from the customer's issued financial fund transfer voucher to the merchant's account (capable of receiving this type of funds).

The transaction will be accompanied by an invoice number as referenced by the merchant, in order to allocate the incoming funds to the purchased goods and services. The transaction will also match delivery address, either solely from that which was registered with the funds provider entity by the person who was issued with the financial funds transfer voucher or by assignment from the customer and verification from the listed information from the funds provider entity.

In preference wherein the financial funds transfer voucher is lost and/or funds are not spent for a pre-determined period, the funds issued as part of the financial funds transfer voucher by the funds provider entity may be returned to the person who was issued with the financial funds transfer voucher as part of the original registration process with the funds provider entity by means of a posted bank cheque or by appearance by person at a customer point of contact of the funds provider entity.

In preference this refund means will be an extension of a cash-out feature, only to be incorporated if the user registers the financial funds transfer voucher with an affiliated financial institution.

In preference the cash-out means will involve participating financial institutions allowing a registered customer who has been issued with a financial funds transfer voucher to claim the remaining funds on the voucher as cash. Preferably the method will be by posted bank cheque in the name of the customer who was issued with the financial funds transfer voucher, or at the financial institution, that being a certified partner of the funds provider entity of the secure electronic financial funds transfer arrangement, wherein the address and identity of those seeking funds may be verified. Preferably the cash-out means is not intended as a frequent usage feature of the arrangement, though it can be used as such to securely transport large sums of money as a small and secure package.

In one embodiment of the invention the card will function as an electronic replacement for cash in configuration where it can only be used to purchase items that will be delivered to the pre-registered address and not items that are a non-addressed based service or are available over the counter or on a pick-up basis.

For the purpose of security the address to which the card is associated will only be available to the merchant from which the items are purchased.

At this level there is only minimal level authentication in operation that being that the item can be purchased with the voucher without the need for a PIN or password, secure in the knowledge that the merchant will only receive the address to which the voucher has been pre-registered. This mode of operation does not protect against organised fraud involving any persons in association with the merchants or the merchants themselves or local opportunists that might wait at the address should they be familiar with the person which whom the voucher is registered.

In some embodiments of the invention there can be available single use, limited value issued vouchers. Under this system the voucher can be purchased and delegated to third party purchasing agents/persons for the purpose of paying for the goods to be delivered to a pre-designated address in the fashion as described above.

At this level the usage for the customer functions as in other modes introduced above, however provides additional piece of mind for customers that the merchant is known to the operators of the fund provider entity and has passed a rudimentary security and authentication process. At this level the certification of the merchant may include procedures not limited to, a test transaction (operated in the blind), a verification transaction (operated in a seen), a statement of guarantee and the possibility of the commitment of a guarantee or issuance from transaction completion but specifically not for item satisfaction.

### BRIEF DESCRIPTION OF THE DRAWINGS

FIG. 1 is a schematic version showing a preferred embodiment of the secured electronic financial funds transfer arrangement of this invention.

FIG. 2 is a further preferred embodiment of the electronic financial funds transfer arrangement of this invention.

FIG. 3 is a still further preferred embodiment of the secure electronic financial funds transfer arrangement of this invention.

### DETAILED DESCRIPTION OF THE DRAWINGS

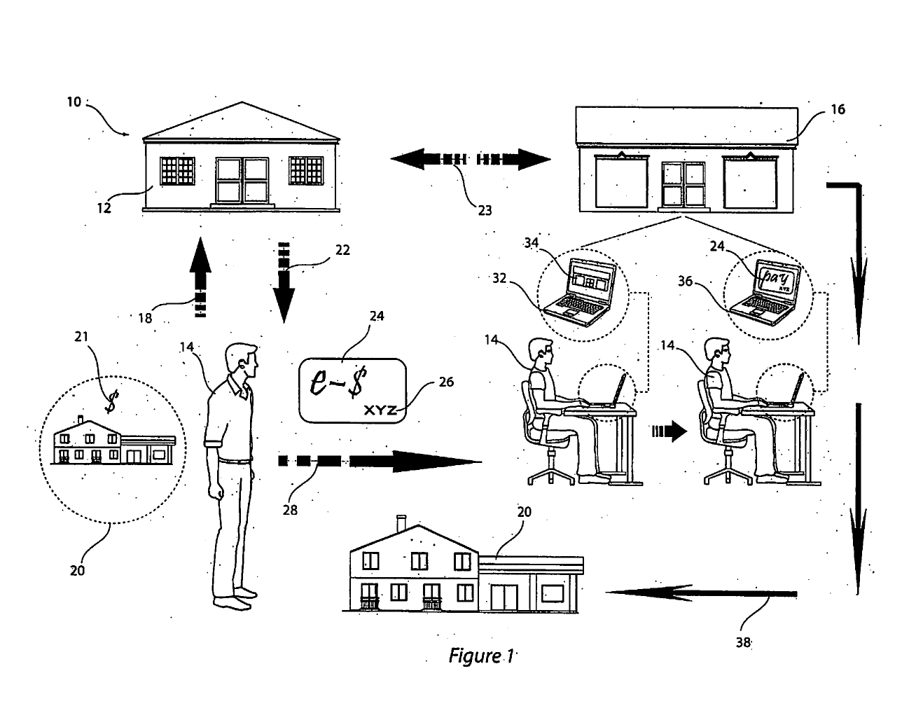

Referring to the illustrations now in greater details and firstly FIG. 1 wherein shown generally in the schematic illustration as (10) is the secure electronic financial funds transfer arrangement of this invention.

There is a funds provider entity (12) a customer (14) and a merchant (16).

The customer by way of a registration means (18) interacts with the funds provider entity (12) providing at least details of a fixed address (20) to which all deliveries associated with the use of an issued voucher (24) from the funds provider entity will be directed to the customer's (14) preferred address shown generally as (20). As part of the registration process the customer (14) can also enter details of the means (21) to which it will pay for the voucher that will be issued by the funds provider entity (12).

Once the customer (14) has been issued with the voucher through the dealing shown by arrow (22) the voucher (24) will include a voucher number (26) which could also include as introduced above a nondescript identification as well.

The customer (14) then is able to proceed shown by way of arrow (28) to commence an electronic financial exchange with the merchant (16) through the merchant's web-site shown generally as (30) and upon screens (32) and (36) to which the customer (14) has purchased articles (34) and upon prompting on-screen (36) now requires to make a payment to which the customer (14) then inserts the number (26) on the voucher (24).

The merchant (16) then begins a verification or authentication step shown by arrow (23) with the funds provider entity (12) wherein as part of the verification and authorisation process between the merchant and the funds provider entity recognition of the identification number (26) of the voucher (24) will confirm the delivery address of the goods (34) purchased in the transaction that has been completed on-screen (36) at the web address (30) of the merchant (16).

As part of the verification process the preferred delivery address inserted by the customer on the web-site can also be compared to that held and stored at the database of the funds provider entity originally detailed during the registration process by the customer (14) with the funds provider entity (12) when the voucher (24) was being issued.

Accordingly once authentication and verification has been completed (23) the goods can then be delivered (38) to the unaltered address (20) that was first listed by the customer (24) when registering with the funds provider entity (12) shown generally as (20).

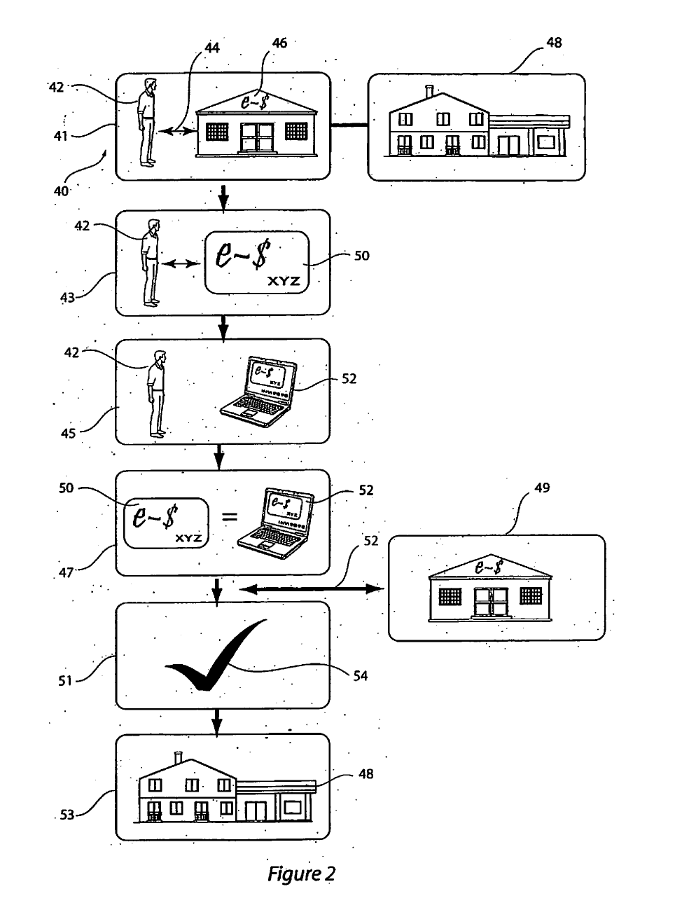

FIG. 2 simply shows another preferred embodiment fairly much consistent with the embodiment shown in the description shown in FIG. 1 wherein a series of steps (41), (43), (45), (47), (49), (51) and (53) ultimately sees the exchange of goods between a customer and a merchant utilising an electronic transfer means by which for the most part the identity of the customer to the merchant can remain limited and irrespective of who is using the voucher involved in the payment of the goods, these goods purchased under the voucher will be only sent not to the address listed by the user of the voucher with the merchant, but in fact the address that was registered when the voucher was first issued from the funds provider entity.

In the example shown in FIG. 2 a customer (42) applies (44) to the funds provider entity (46) wherein part of the application process to be issued with a voucher (50) to be used in electronic transfer between a customer and a merchant requires the customer (42) to list his or her address to a delivery of goods and services purchased under the voucher will be sent to.

Once the customer (42) is in possession of the issued voucher (50) from the funds provider entity (46) the customer (42) is then able to purchase goods from the merchant and may be issued with an invoice number which in this example has been issued by the numbers 12345.

The customer (42) requests payment with the voucher issued by the funds provider entity confirms correct entry of the number issued on the voucher given to the customer.

As shown generally by arrow (52) upon confirmation of the transaction, a request is forwarded to the funds provider entity (49) by the merchant.

The account number and nondescript identifier may be forwarded to the merchant from the funds provider entity facilities, along with the requested delivery address. The nondescript identifier and address may be sent unencrypted as text or may be sent by means of a true false field to the merchant, so as to verify for the merchant forwarding of the correct details from the database to the merchant.

The request is processed by the funds provider entity and the details are forwarded to the merchant. Here, as shown generally by way of (54) and also (48), the one and only registered delivery address can be compared with the requested address. If the address and the nondescript identifier are confirmed and matched, the merchant can complete the transaction and either with or without verification, the funds provider entity can forward the funds to the merchant so the goods then can be on-forwarded to the selected address (48) made by the customer when registering for the issued voucher (50).

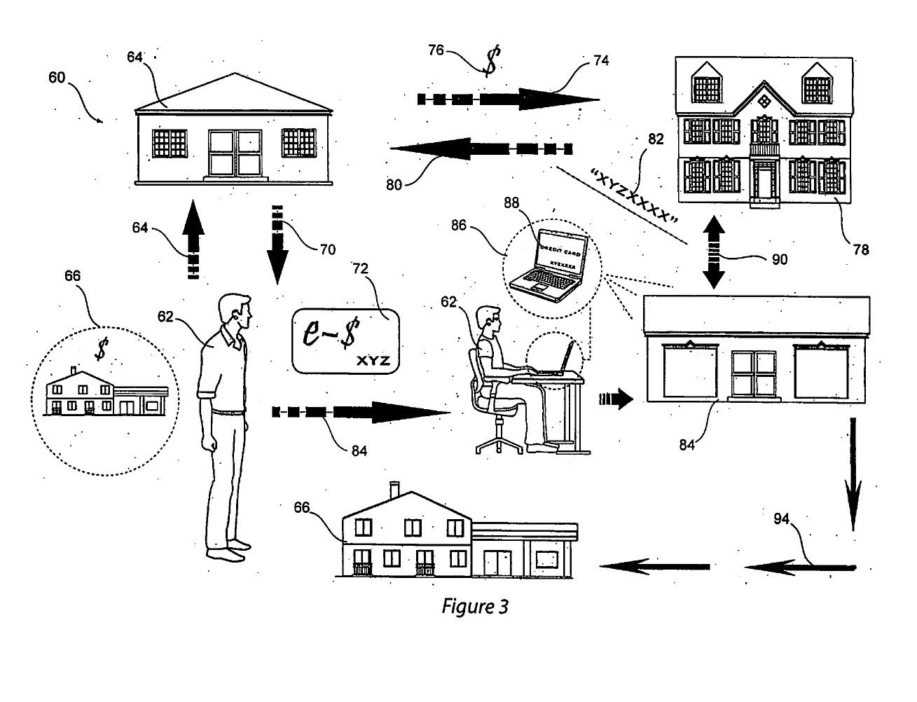

FIG. 3 provides an opportunity wherein the secure electronic financial funds transfer arrangement (60) can include the funds provider entity (64), the customer (62) who will input (64) his or her delivery address details and means in which the issued voucher from the funds provider entity (64) will be paid wherein then thereafter the funds provider entity can issue (70) a voucher (72) with a credit card number.

This credit card number has been made available through the interaction between the funds provider entity (60) and a credit card company such as Visa, MasterCard, American Express and so forth shown generally as (78) in the illustrations.

In this embodiment of the invention it is envisaged that the funds provider entity (64) will communicate with the credit card company (78) shown by way of arrow (74) with a required amount to which it will guarantee. To this listed amount to which the funds provider entity will guarantee the credit card company will issue the credit card number (80) to which would then be relayed (80) back across to the funds provider entity (68). The customer (62) can then commence an electronic commercial transaction on-line shown generally through arrow (84) wherein once the screen (86) which is the web-site of the merchant (84) prompts the customer (64) to enter in the credit card details (88) the customer (62) can then do that wherein the credit card details inserted as required can then be verified by the merchant's store with the credit card company (78) but at the same time the credit card company inherently through its logic knows that the issued credit card number (82) which was given to the funds provider entity (68) also requires to send an authentication or comment to the merchant stating that the goods purchased during this transaction must be sent to the registered address demanded upon by the funds provider entity (68) who guarantee the original amount (76) issued on this credit number (82).

As can be seen by the arrow the bottom line is that the merchant (84) sends the goods purchased (94) to the home address (66) that was provided by the funds provider entity (68) during the initial transaction between the funds provider entity (68) and the credit card company or facility (78).

1. A secure electronic financial funds transfer arrangement for the commercial trading of goods and/or services between a merchant and a customer wherein the identity of the customer remains optionally unknown to the merchant albeit the funds transfer between the merchant and the customer when goods and services are bought will result in those purchased goods and services being sent to an incorruptible (non editable) customer address, said funds transfer arrangement including:
a funds provider entity;
said funds provider entity making available a financial funds transfer voucher through a registration means with a customer seeking to purchase goods and services from a merchant utilising electronic means;
said registration means requiring the customer to make a payment to the funds provider entity that will match the value, or a substantial amount thereto of the financial funds transfer voucher issued by the funds provider entity, and for the customer to list as part of the registration means a delivery address of the customer for all purchases made from the issued financial funds transfer voucher of the funds provider entity during commercial dealings with the merchant in the electronic trading medium;
a verification means available to the merchant such that when a customer makes a selection of goods and/or services of the merchant and wherein the customer uses the voucher issued by the funds provider entity for payment of the purchased goods and services from the merchant by electronic means, the merchant is able to utilise a verification means with the funds provider entity to determine that the voucher can financially cover said transaction between the customer and the merchant; and
whereupon said validation of the voucher issued by the funds provider entity to the customer will result in the transfer of financial funds from the funds provider entity to the merchant and the delivery of the selected goods and/or services to the registered address made by the customer during the registration process before the financial funds transfer voucher was issued by the funds provider entity.

2. The arrangement of claim 1 wherein the registration means between the customer seeking to be issued with a financial funds transfer voucher and the funds provider entity further including a nondescript identifier, for the purpose of verifying the correct entry of an account during the verification stage between the merchant and the funds provider entity.

3. The arrangement of claim 1 wherein the financial funds transfer voucher includes a card, ticket, docket, invoice or receipt of purchase from the funds provider entity wherein the number presented on said card, ticket, docket, invoice or receipt of purchase of the funds provider entity represents a temporary, short-term, long-term, lifetime or an account over a period of time to be limited to the value placed on the card, ticket, docket, invoice or receipt of purchase by the funds provider entity.

4. The arrangement of claim 1 further including a means for altering a delivery address of an issued financial funds transfer voucher when the customer who is issued with the financial funds transfer voucher during registration has vacated an existing delivery address wherein said relocation of address makes the original delivery address unavailable or invalid and wherein substituted therein is a new delivery address of the customer.

5. The arrangement of claim 4 the means for altering delivery address includes a closed loop of non transferable funds, such as a mail out of a named bank cheque to the registered address and purchase of a new voucher, or presentation to the funds provider entity; postal service, newsagent=of sufficient identity in order to transfer the funds out, or across to a new voucher or address.

6. The arrangement of claim 1 wherein the registration means between the customer seeking the purchase of a financial funds transfer voucher with the funds provider entity is through a kiosk service or electronic funds transfer machine.

7. The arrangement as in 6 wherein the process is mediated or conducted by a person such as a representative of the funds provider entity, or a recognised service provider such as a postal/courier agency, newsagent or supermarket.

8. The arrangement of claim 7 wherein the electronic funds transfer machine would include a customer interactive screen wherein the customer upon purchasing the financial funds transfer voucher inputs his or her address and provide means or information about payment for the financial funds transfer voucher.

9. The arrangement of claim 8 wherein the electronic funds transfer machine to which a customer is interacting with the funds provider entity to be issued with a financial funds transfer voucher, further includes a verification comparison step wherein recognisable identity documentation of the customer, including driver's license, national identity card and/or passport would be compared with the address detailed by the customer seeking the issuance of a financial funds transfer voucher from the funds provider entity.

10. The arrangement of claim 8 wherein a person, representative of the funds provider entity verifies the identity/validity of identifying documents of the customer purchasing the funds transfer voucher and has the capacity to complete the issuing of the voucher medium to the customer.

11. The arrangement of claim 1 wherein a customer seeking the purchase of a financial funds transfer voucher from the funds entity provider may utilise the world wide web, or other network/connection to enter in registration details including that of the fixed delivery address and the means and amount for the payment of the financial funds transfer voucher.

12. The arrangement of claim 1 wherein the registration means allows for the completion of the registration process by the customer seeking the issuing of the financial funds transfer voucher to do so by telephone, either by operator or by menu governed service.

13. The arrangement of claim 1 wherein once the registration has been completed between the customer and the funds provider entity all address entry methods may be verified by a secondary process after registration, where a confirmation letter may be sent to the registered address.

14. The arrangement of claim 1 wherein the verification either can contain a verification code which can be subsequently entered into a web-site or telephone menu system to activate the financial funds transfer voucher.

15. The arrangement of claim 1 wherein the voucher includes the use of a nondescript identifier, used for the purpose of the customer being able to verify correct entry of their financial funds transfer voucher.
